(19) United States
(12) Patent Application Publication
(10) Pub. No.: US 2014/0296416 A1
(43) Pub. Date: Oct. 2, 2014

(54) STABILIZED POLYAMIDE/ABS MOLDING MASSES

(71) Applicant: STYROLUTION GMBH, Frankfurt am Main (DE)

(72) Inventors: Rolf Minkwitz, Mannheim (DE); Marko Blinzler, Mannheim (DE); Rebekka Von Benten, Mannheim (DE); Piyada Charoensirisomboon, Mannheim (DE)

(21) Appl. No.: 14/350,700

(22) PCT Filed: Oct. 5, 2012
(86) PCT No.: PCT/EP2012/069742

§ 371 Date: Apr. 9, 2014

(30) Foreign Application Priority Data
Oct. 13, 2011 (EP) 11185103.6

(51) Int. Cl. C08L 77/02

(52) U.S. Cl. CPC C08L 77/02
USPC 524/504

(57) ABSTRACT

Thermoplastic molding compositions comprising the following components:
a) 3 to 91.8 wt % of a polyamide, as component A
b) 3 to 91.8 wt % of a styrene copolymer, as component B
c) 5 to 91.8 wt % of an impact-modifying grafted rubber, as component C
d) 0.2 to 1.5 wt % of a compound of formula (I), as component D:

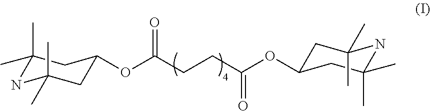

e) 0 to 0.9 wt % of a mixture of formula (II), as component E:

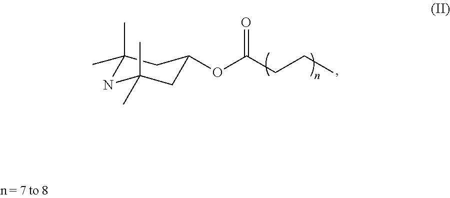

f) 0 to 0.9 wt % of a further stabilizer component F,
g) 0 to 25 wt % of one or more styrene copolymers which include from 0.5 to 5 wt % of maleic anhydride-derived units, as component G,
   and also optionally further added-substance materials, have advantageous weathering properties.

The present invention relates to thermoplastic molding compositions comprising at least one polyamide, at least one styrene copolymer and at least one impact-modifying grafted rubber with olefinic double bonds in the rubber phase.

Stabilized thermoplastic molding compositions based on acrylonitrile-butadiene-styrene copolymers (ABS) are well known and are widely used for many applications because of their favorable performance characteristics.

The literature also discloses thermoplastic molding compositions comprising polyamides, grafted rubbers and at least one styrene-based copolymer (EP-A 0 202 214, EP-A 0 784 080, EP-A 0 402 528, WO 2005/071013). Thermoplastic molding compositions of this type are used in particular in the production of molded articles, moldings, self-supporting films and sheets, fibers and foams, of which, for example, the moldings can be employed as automotive components.

EP-A 1 263 855 discloses stabilized molding compositions which, in addition to a polyethylene or polypropylene or a copolymer thereof, may further comprise compounds of hereinbelow recited formulae (I), (II), (Ill), (IV), (V) or (VI) of the present invention in combination with an acrylate rubber-modified vinylaromatic copolymer (ASA=acrylonitrite/styrene/acrylate) or polyamide in amounts up to 1.5%. However, no butadiene rubber-modified molding compositions are described. The known molding compositions are disadvantageous because inter alia their notched impact strength is low.

U.S. Pat. No. 4,692,486 discloses stabilizer mixtures comprising compounds of formulae (I) and (III) of the present invention for polypropylene, polyurethane and polystyrene, wherein the individual stabilizer components are each employed at not more than 0.1 wt %. This embodiment is disadvantageous because of the low notched impact strength of the molding compositions.

DE-A 103 16 198 discloses stabilizer mixtures for different types of thermoplastic polymers, such as polypropylene. The stabilizer mixtures are ternary mixtures.

A multiplicity of possible generic and specific compounds are described for each of the three components of this stabilizer mixture. A stabilizer mixture comprising compounds of formulae (I), (II) and (III) of the present invention is described as merely one of many possibilities. Each of the three stabilizer components may preferably be present in amounts of 0.05 to 1 wt %, based on the organic material. This embodiment is disadvantageous because of the severe decrease in multi-axial toughness during weatherization.

It is an object of the present invention to provide improved molding compositions on the basis of polyblends of polyamide with acrylonitrile/butadiene/styrene copolymers. The present invention accordingly provides improved thermoplastic molding compositions comprising (or else consisting of):
a) 3 to 91.8 wt % of at least one polyamide, as component A,
b) 3 to 91.8 wt % of one or more styrene copolymers without any maleic anhydride-derived units, as component B,
c) 5 to 91.8 wt % of one or more impact-modifying grafted rubbers with olefinic double bonding in the rubber phase, as component C,
d) 0.2 to 1.5 wt % of a compound of formula (I), as component D:

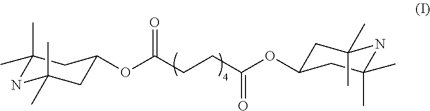

e) 0 to 0.9 wt % of a mixture of formula (II), as component E:

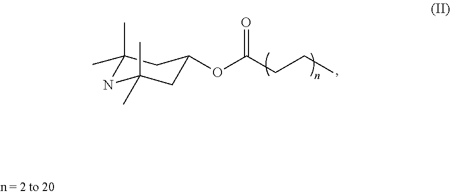

especially of the following formula

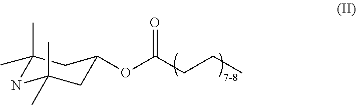

f) 0 to 0.9 wt % of a compound of formula (III), as component F:

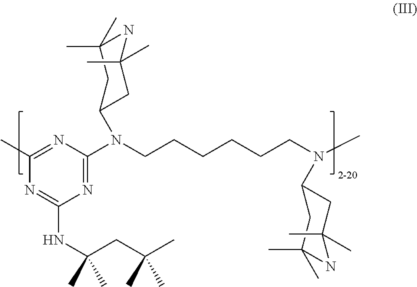

or 0 to 0.9 wt % of a compound of formula (IV):

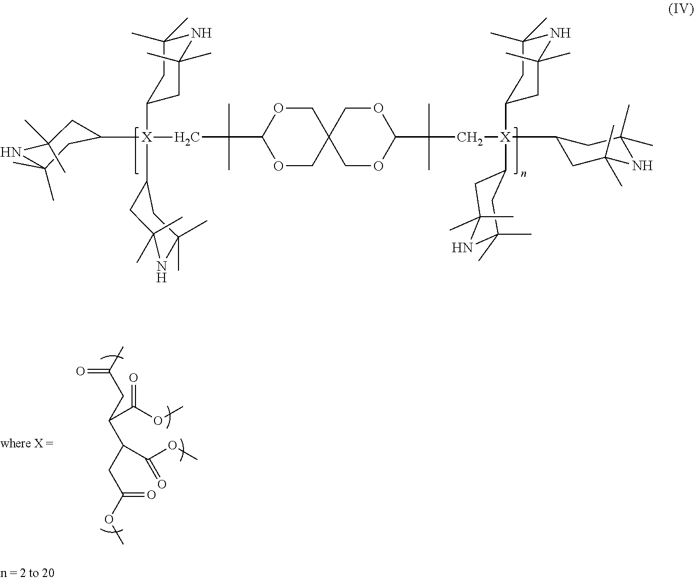

or 0 to 0.9 wt % of a compound of formula (V):

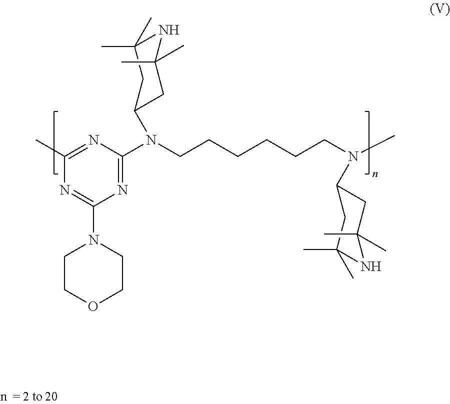

or 0 to 0.9 wt % of a compound of formula (VI):

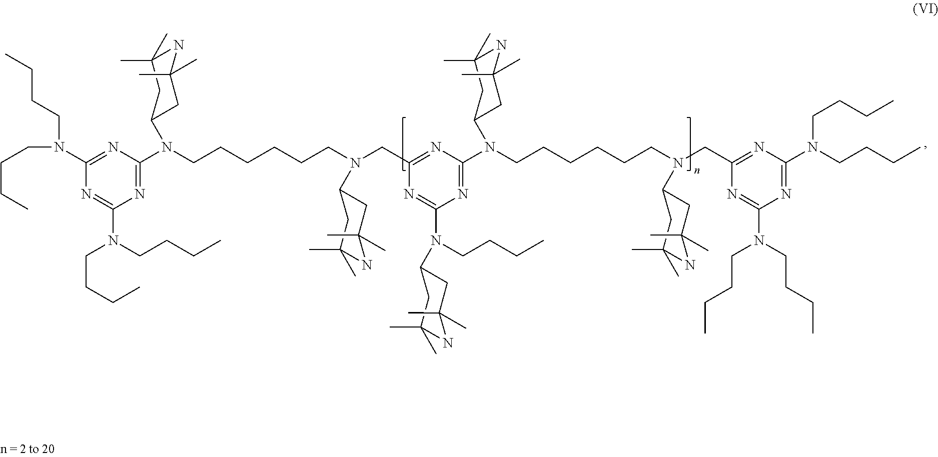

g) 0 to 25 wt %, but often 1 to 25 wt % of one or more styrene copolymers which, based on overall component G, include from 0.5 to 5 wt % of maleic anhydride-derived units, as component G,
h) 0 to 40 wt % of one or more further rubbers,
i) 0 to 40 wt % of one or more added-substance materials other than components D, E, F, G, and H, as component I, and
j) 0 to 40 wt % of one or more fibrous or particulate fillers, as component J.

The molding compositions are subject to the proviso that when component E amounts to precisely 0 wt % (i.e., no component E is present), component F comprises from 0.01 to 0.9 wt %, preferably 0.1 to 0.8 wt %, more preferably 0.2 to 0.8 wt % of one or more of compounds III, IV, V or VI, wherein the weight % are each based on the overall weight of components A to J, and these add up to 100 wt %.

Preference is also given to molding compositions comprising 0.2 to 1.5 wt %, often 0.3 to 1.1 wt % of component D, and additionally 0.1 to 0.8 wt % of component E (such as for instance Cyasorb 3853).

The invention further provides a thermoplastic molding composition which is characterized in that the swelling index of component C is in the range from 7 to 20.

The invention further provides a thermoplastic molding composition wherein component B comprises a copolymer of acrylonitrile, styrene and/or α-methylstyrene, phenylmaleimide, methyl methacrylate or mixtures thereof.

The invention further provides a thermoplastic molding composition wherein component C comprises a mixture of an acrylonitrile-butadiene-styrene (ABS) graft polymer comprising 50 to 80 wt %, based on C, of an elastomer-crosslinked butadiene polymer B1 and 50 to 20 wt %, based on C, of a grafted sheath C2 formed from a vinylaromatic monomer and one or more polar, copolymerizable, ethylenically unsaturated monomers, optionally a further copolymerizable, ethylenically unsaturated monomer in a weight ratio of from 85:15 to 65:35.

The invention further provides a thermoplastic molding composition wherein the average particle diameter of component C is between 50 to 800 nm.

The invention further provides a thermoplastic molding composition wherein components D:E are used in a weight ratio of from 4:1 to 0.25:1.

The invention further provides a thermoplastic molding composition wherein the vinylaromatic component in C2 comprises styrene or α-methylstyrene.

The invention further provides a thermoplastic molding composition wherein the ethylenically unsaturated component in C2 comprises acrylonitrile and/or alkyl methacrylates and/or alkyl acrylates having C₁-C₈ alkyl.

The invention further provides a thermoplastic molding composition wherein component C comprises a rubber which has a bimodal particle size distribution.

The invention further provides a thermoplastic molding composition wherein component G includes from 1.0 to 2.5 wt % of maleic anhydride-derived units.

The invention further provides a thermoplastic molding composition wherein component G includes from 1.7 to 2.3 wt % of maleic anhydride-derived units.

The invention further provides a thermoplastic molding composition wherein component A includes from 0.05 to 0.5 wt % of triacetonediamine (TAD) end groups.

The invention further provides a process for producing thermoplastic molding compositions as described above, wherein components A, B, C, D and G, and also optionally, E, F, H, I and J are mutually mixed with one another in any desired order at temperatures of 100 to 300° C. and a pressure of 1 to 50 bar, then kneaded and extruded. The invention also provides a process for producing thermoplastic molding compositions by first premixing a portion of component C with a portion of component B to form a masterbatch in a ratio of from 1:1 to 1:2 and then mixing said masterbatch with further components A, B, C, D and G and also optionally E, F, H, I and J to form the thermoplastic molding composition.

The use of the abovementioned thermoplastic molding compositions for production of molded articles, self-supporting films and sheets or fibers is likewise part of the subject-matter of the invention, as is the use of the thermoplastic molding compositions for production of molded articles for automotive components or parts of electronic equipment.

The invention further provides the molded articles, fibers or self-supporting films and sheets comprising/consisting of a thermoplastic molding composition as described above. The invention further provides processes for producing these molding compositions, their use for producing self-supporting films and sheets, molded articles or fibers, and also these self-supporting films and sheets, molded articles or fibers themselves. The specific selection of the individual components and of their specific proportions is essential to the present invention and endows the molding compositions of the present invention with an improved weathering resistance, i.e., an improved heat, light and/or oxygen resistance, over the known stabilized molding compositions. The articles, processes and uses provided by the present invention will now be more particularly described.

The molding compositions of the present invention preferably comprise, based on the overall weight (mass) of components A, B, C, D, G (essential components) and optionally E, F, H, I and J (optional components), which overall weight adds up in total to 100 weight percent:
a) 3 to 91.8 wt %, preferably 25 to 75 wt %, more preferably 30 to 70 wt % of component A,
b) 3 to 91.8 wt %, preferably 10 to 40 wt %, more preferably 14 to 30 wt % of component B,
c) 5 to 91.8 wt %, preferably 10 to 40 wt %, more preferably 14 to 35 wt % of component C,
d) 0.2 to 1.5 wt %, preferably 0.2 to 1.2 wt %, more preferably 0.3 to 1.1 wt % of component D,
e) 0 to 0.9 wt %, preferably 0.2 to 0.8 wt %, more preferably 0.2 to 0.7 wt % of component E,
   with the proviso that when component E amounts to 0 wt % (i.e., no component E is present), component F amounts to 0.01 to 0.9 wt %, preferably 0.1 to 0.8 wt %, more preferably 0.2 to 0.8 wt % of one or more of compounds III, IV, V or VI,
f) 0 to 0.9 wt %, preferably 0.1 to 0.8 wt %, more preferably 0.2 to 0.8 wt % of component F,
g) 1 to 25 wt %, preferably 2 to 10 wt %, more preferably 3 to 7 wt % of component G,
h) 0 to 30 wt %, preferably 0 to 20 wt %, often 3 to 20 wt %, more preferably 5 to 17 wt % of component H,
i) 0 to 40 wt %, preferably 0 to 30 wt %, in particular 0 to 17 wt % of component I, and
j) 0 to 50 wt %, preferably 0 to 40 wt %, in particular 10 to 35 wt % of component J.

Instead of the upper limit being 91.8 wt % for components A, B and C it is often 90.8 wt % and preferably 90 wt %.

A molding composition according to the present invention consists for example, based on the overall weight of all components, which as overall weight add up to all together 100 weight percent:
a) 30 to 45 wt % of component A,
b) 14 to 20 wt % of component B,
c) 14 to 35 wt % of component C,
d) 0.3 to 1.1 wt % of component D,
e) 0 to 0.9 wt %, preferably from 0.2 to 0.7 wt % of component E,
f) 0.2 to 0.8 wt % of component F,
g) 3 to 7 wt % of component G,
h) 0 to 20 wt % of component H,
i) 0 to 17 wt % of component I,
j) 0 to 40 wt % of component J,
   with the proviso that when component E amounts to precisely 0 wt %, component F amounts to 0.2 to 0.8 wt % of one or more of compounds III, IV, V or VI.

Often the composition comprises not only a component D but also a (at least one) component E (the substance Cyasorb 3853, in particular).

The weight ratio of component D to component E is generally in the range from 4:1 to 0.25:1, preferably in the range from 4:1 to 1:1 and more preferably in the range from 3:1 to 1:1.

The component E:F weight ratio is often in the range from 2:1 to 0.5:1, if a component F is present.

### COMPONENT A

Component A of the thermoplastic molding compositions according to the present invention comprises one or more polyamides. This component A is often comprised in the molding compositions in an amount of 30 to 70 wt %. Component A often comprises a polyamide with at least one end group that is derivable from the piperidine compound triacetonediamine (TAD). The polyamide preferably has from 0.05 to 0.5 wt %, more preferably 0.1 to 0.2 wt %, of triacetonediamine (TAD) end groups, based on overall component A.

Component A may comprise TAD-free polyamides, TAD-containing polyamides or else mixtures of polyamides having TAD end groups with polyamides without TAD end groups. All together, based on component A, from 0.1 to 0.2 wt % of triacetonediamine end groups may preferably be present. Preferably from 0.14 to 0.18 wt % of TAD end groups is present, in particular from 0.15 to 0.17 wt % of TAD end groups.

Mixtures of two or more different polyamides can also be used as component A. For instance, polyamides which differ in their core structure but have the same end group can be used. But it is also possible to employ polyamides having the same core scaffold and end groups that derive from different piperidine compounds. It is further possible to use mixtures of polyamides having different content levels of end groups that derive from piperidine compounds (such as TAD).

By polyamides are meant homopolymers or copolymers of synthetic long-chain polyamides having recurring amide groups as an integral part of the main polymer chain.

Examples of polyamides of this type are:
nylon-6 (polycaprolactam), nylon-6,6 (polyhexamethyleneadipamide),
nylon-4,6 (polytetramethyleneadipamide),
nylon-5,10 (polypentamethyleneadipamide),
nylon-6,10 (polyhexamethylenesebacamid), nylon-7 (polyenantholactam),
nylon-11 (polyundecanolactam), nylon-12 (polydodecanolactam).

These polyamides are known to bear the generic name nylon. Polyamides are obtainable by two methods in principle.

In the polymerization from dicarboxylic acids and diamines and also in the polymerization from amino acids, the amino and carboxyl end groups of the starting monomers or oligomers react with one another to form an amide group and water. The water may be subsequently removed from the polymer mass. In the polymerization from carboxamides, the amino and amide end groups of the starting monomers or oligomers react with one another to form an amide group and ammonia. The ammonia may subsequently be removed from the polymer mass.

Useful starting monomers or oligomers for producing polyamides include for example:
(1) C₂-C₂₀, preferably C₃-C₁₈ amino acids, such as 6-aminocaproic acid, 11-aminoundecanoic acid, and also their dimers, trimers, tetramers, pentamers or hexamers,
(2) C₂-C₂₀ amino acid amides, such as 6-aminocaproamide, 11-aminoundecanoamide and also their dimers, trimers, tetramers, pentamers or hexamers,
(3) reaction products of (3a) C₂-C₂₀, preferably C₂-C₁₂ alkyldiamines, such as tetramethylenediamine or preferably hexamethylenediamine, with
   (3b) a C₂-C₂₀, preferably C₂-C₁₄ aliphatic dicarboxylic acid, such as sebacic acid, decanedicarboxylic acid or adipic acid, and also their dimers, trimers, tetramers, pentamers or hexamers,
(4) reaction products of (3a), with (4b) a C₈-C₂₀, preferably C₈-C₁₂ aromatic dicarboxylic acid or its derivatives for example chlorides, such as 2,6-naphthalenedicarboxylic acid, preferably isophthalic acid or terephthalic acid, and also their dimers, trimers, tetramers, pentamers or hexamers,
(5) reaction products of (3a), with (5b) a C₉-C₂₀, preferably C₉-C₁₈ arylaliphatic dicarboxylic acid or its derivatives, for example chlorides, such as o-, m- or p-phenylenediacetic acid, and also their dimers, trimers, tetramers, pentamers or hexamers,
(6) reaction products of (6a), C₆-C₂₀, preferably C₆-C₁₀ aromatic diamines, such as m- or p-phenylenediamine, with (3b) and also their dimers, trimers, tetramers, pentamers or hexamers,
(7) reaction products of (7a), C₇-C₂₀, preferably C₈-C₁₈ arylaliphatic diamines, such as m- or p-xylylenediamine, with (3b) and also their dimers, trimers, tetramers, pentamers or hexamers,
(8) monomers or oligomers of a C₂-C₂₀, preferably C₂-C₁₈ arylaliphatic or preferably aliphatic lactam, such as enantholactam, undecanolactam, dodecanolactam or caprolactam,
   and also homopolymers, copolymers or mixtures of such starting monomers or oligomers.

Preference is given to those starting monomers or oligomers which on polymerization lead to the polyamides nylon-6; nylon-6,6; nylon-4,6; nylon-5,10; nylon-6,10; nylon-7; nylon-11; nylon-12; in particular to nylon-6 and nylon-6,6.

The optionally present triacetonediamine (TAD) end groups derive from 4-amino-2,2,6,6-tetramethylpiperidine. The attachment of the TAD to the polyamide may be via an amino or carboxyl group. So 4-carboxy-2,2,6,6-tetramethylpiperidine may also be concerned for example.

The polymerization of the monomers for polyamides A is known per se or may be effected according to methods known per se. Thus, addition polymerization or the condensation polymerization of the starting monomers, for example in the presence of the piperidine compounds, may be carried out under customary processing conditions, in which case the reaction can be carried out as a continuous operation or as a batch operation. The piperidine compounds, if present, can also be combined with a chain transfer agent as typically used for the production of polyamides. Particulars regarding suitable methods are found for example in WO 1995/28443, WO 1999/41297 or DE-A 198 12 135. The TAD compound is attached to the polyamide by reacting at least one of the amide-forming groups. The secondary amino groups of the piperidine ring systems do not react here because of steric hindrance.

It is also possible to use polyamides formed by copolycondensation of two or more of the abovementioned monomers or components thereof, e.g., copolymers of:
adipic acid, isophthalic acid or terephthalic acid and hexamethylenediamine or copolymers of caprolactam, terephthalic acid and hexamethylenediamine.

Partly aromatic copolyamides of this type comprise from 40 to 90 wt % of units derived from terephthalic acid and hexamethylenediamine. A small proportion of the terephthalic acid, preferably not more than 10 wt % of the total aromatic dicarboxylic acids employed, may be replaced by isophthalic acid or other aromatic dicarboxylic acids, preferably those in which the carboxyl groups are para disposed. One partly aromatic polyamide is nylon-9,T; it derives from nonanediamine and terephthalic acid.

The monomers used may also be cyclic diamines, such as those of general formula (VII):

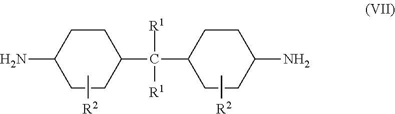

in which
R¹ is hydrogen or C₁-C₄ alkyl,
R² is C₁-C₄ alkyl or hydrogen.

Particularly preferred diamines of formula (VII) are bis(4-aminocyclohexyl)methane, bis(4-amino-3-methylcyclohexyl)methane, bis(4-aminocyclohexyl)-2,2-propane or bis(4-amino-3-methylcyclohexyl)-2,2-propane.

Useful diamines of formula (VII) further include 1,3- or 1,4-cyclohexanediamine or isophoronediamine. In addition to the units which derive from terephthalic acid and hexamethylenediamine, partly aromatic copolyamides comprise units derived from ε-caprolactam, and/or units derived from adipic acid and hexamethylenediamine.

The proportion of units derived from ε-caprolactam is up to 50 wt %, preferably from 20 to 50 wt %, in particular from 25 to 40 wt %, whereas the proportion of units derived from adipic acid and hexamethylenediamine is up to 60 wt %, preferably from 30 to 60 wt % and in particular from 35 to 55 wt %.

The copolyamides may also comprise not only units of ε-caprolactam but also units of adipic acid and hexamethylenediamine, in this case it should be ensured that the proportion of units which are free of aromatic groups is at least 10 wt %, preferably at least 20 wt %. In this case there is no particular limit to the ratio of units which derive from ε-caprolactam and from adipic acid and hexamethylenediamine. There are many applications for which polyamides comprising 50 to 80, in particular 60 to 75 wt % of units derived from terephthalic acid and hexamethylenediamine and 20 to 50, preferably 25 to 40 wt % of units derived from ε-caprolactam will prove advantageous. Partly aromatic copolyamides are obtainable for example by the methods described in EP-A 0 129 195 and EP-A 0 129 196.

Preferred partly aromatic polyamides are those with a content of triamine units, in particular units of dihexamethylenetriamine of below 0.555 wt %, i.e., from 0 to 0.554 wt %, preferably from 0 to 0.45 wt %, more preferably from 0 to 0.3 wt %.

Linear polyamides having a melting point above 200° C. are preferred for use as component A.

Preferred polyamides are polyhexamethyleneadipamide, polyhexamethylene-sebacamide and polycaprolactam and also nylon 6/6T and nylon 66/6T and also polyamides comprising cyclic diamines as comonomers.

Polyamides in general have a relative viscosity in the range from 2.0 to 5, as determined on a 1 wt % solution in 96 wt % sulfuric acid at 23° C., which corresponds to a molecular weight (number average) of 15 000 to 45 000. Polyamides having a relative viscosity of 2.4 to 3.5, in particular 2.5 to 3.4, are used with preference.

There may additionally also be mentioned polyamides as obtainable, for example, by condensation of 1,4-diaminobutane with adipic acid at elevated temperature (polyamide-4,6). Methods of making polyamides with this structure are described for example in EP-A 038 094, EP-A 038 582 and EP-A 039 524. Preferred polyamides are also described in the experimental section.

### COMPONENT B

Component B of the thermoplastic molding composition according to the present invention comprises one or more styrene copolymers. Any suitable comonomers may be present in these copolymers as well as styrene. Component B is preferably a styreneacrylonitrile copolymer (SAN), alpha-methylstyrene-acrylonitrile copolymer or N-phenylmaleimide-styrene copolymer. The components frequently have a viscosity number VN of not more than 85 ml/g. The viscosity number (VN) is measured to German standard specification DIN 53727 at 25° C. on a 0.5 wt % solution in dimethylformamide; this method of measurement also holds for any hereinbelow recited viscosity numbers.

Component B, especially the SAN, is often comprised in the molding composition in an amount of 14 to 30 wt %. Preferred components B are constructed from 50 to 90 wt %, preferably 60 to 85 wt %, in particular 70 to 83 wt %, of styrene and 10 to 50 wt %, preferably 15 to 40 wt %, in particular 17 to 30 wt %, of acrylonitrile and also 0 to 5 wt %, preferably 0 to 4 wt %, in particular 0 to 3 wt %, of further monomers, wherein the wt % are each based on the weight of component B and add up to 100 wt %.

Preferred components B are constructed from 50 to 90 wt %, preferably 60 to 80 wt %, in particular 65 to 78 wt %, of α-methylstyrene and 10 to 50 wt %, preferably 20 to 40 wt %, in particular 22 to 35 wt %, of acrylonitrile and also 0 to 5 wt %, preferably 0 to 4 wt %, in particular 0 to 3 wt %, of further monomers, wherein the wt % are each based on the weight of component B and add up to 100 wt %.

Likewise preferred components B are mixtures of these styrene-acrylonitrile copolymers and α-methylstyrene-acrylonitrile copolymers with N-phenylmaleimide-styrene copolymers or N-phenylmaleimide-styrene-acrylonitrile terpolymers.

The further monomers referred to above can be any copolymerizable monomers, for example p-methylstyrene, t-butylstyrene, vinylnaphthalene, alkyl acrylates and/or alkyl methacrylates, for example those with C₁-C₈ alkyl or, N-phenylmaleimide and mixtures thereof.

The copolymers of component B, preferably the S AN copolymers, are obtainable by known methods. For instance, they are obtainable by free-radical polymerization, in particular by emulsion polymerization, suspension polymerization, solution polymerization or bulk polymerization. They have viscosity numbers in the range from 40 to 160 ml/g, which corresponds to average molecular weights Mw (weight-average value) of 40 000 to 2 000 000 g/mol.

### COMPONENT C

Component C comprises one or more elastomeric graft copolymers of vinylaromatic compounds, in particular of styrene, and vinyl cyanides, in particular acrylonitrile, on polybutadiene rubbers. The amount of component C is often 14 to 35 wt % of the molding composition according to the present invention.

One way to characterize the extent of the crosslinking in crosslinked particles of polymer is to measure the swelling index (SI) which is a measure of the degree to which a more or less crosslinked polymer is swellable by a solvent. Methyl ethyl ketone and toluene are examples of customary swelling agents. The SI of graft copolymer C of the molding compositions according to the present invention is typically in the range SI=7 to 20. Preference is given to an SI of 8 to 15, more preferably of 8 to 13 in toluene.

To determine the swelling index, an aqueous dispersion of graft copolymer C is dried at 80° C. overnight on a metal sheet under slightly reduced pressure (600 to 800 mbar) and nitrogen, leaving a film about 2 mm in thickness. A 1 cm² slice is then cut off and swollen overnight in 50 ml of toluene (or methyl ethyl ketone) in a penicillin bottle. Supernatant toluene is removed by suction, and the swollen film is weighed and dried at 80° C. overnight.

The weight of the dried film is determined. The swelling index is calculated by dividing the weight of the swollen gel by the weight of the dried gel.

Component C consists preferably of one or more impact-modifying grafted rubbers with olefinic double bonding in the rubber phase. Graft polymer C is constructed of a “soft” elastomeric particulate “grafting base” C1, and a “hard graft” C2.

Grafting base C1 is present in a proportion of 40 to 90, preferably 45 to 85 and more preferably 50 to 80 wt %, based on component C. Grafting base C1 is obtained by polymerization of, based on C1, 70 to 100, preferably 75 to 100 and more preferably 80 to 100 wt % of at least one conjugated diene C11, and 0 to 30, preferably 0 to 25 and more preferably 0 to 10 wt % of at least one further monoethylenically unsaturated monomer. Conjugated diene C11 may be butadiene, isoprene, chloroprene or a mixture thereof. Preference is given to using butadiene or isoprene or mixtures thereof, most particularly butadiene.

Constituent C1 of the molding compositions may also comprise, at the expense of monomers C11, further monomers C12 which vary the mechanical and thermal properties of the core within certain limits. Examples of such monoethylenically unsaturated comonomers are: styrene, alpha-methylstyrene, acrylonitrile, maleic anhydride, acrylic acid, methylacrylic acid, maleic acid or fumaric acid. Preference is given to using styrene, α-methylstyrene, n-butyl acrylate or mixtures thereof as monomers C12, more preferably styrene and n-butyl acrylate or mixtures thereof and most preferably styrene. Styrene or n-butyl acrylate or mixtures thereof are used in particular in amounts of together up to 20 wt %, based on C1.

One particular embodiment proceeds from using a grafting base based on C1:
C11 70 to 99.9, preferably 90 to 99 wt % of butadiene, and
C12 0.1 to 30, preferably 1 to 10 wt % of styrene.

Graft C2 is present in a proportion of 10 to 60, preferably 15 to 55 and more preferably 20 to 50 wt %, based on component C.

Graft C2 is obtained by polymerization of, based on C2:

C21 65 to 95 wt %, preferably 70 to 90 wt %, and more preferably 72 to 85 wt % of at least one vinylaromatic monomer;

C22 5 to 35 wt %, preferably 10 to 30 wt %, and more preferably 15 to 28 wt % of acrylonitrile;

C23 0 to 30, preferably 0 to 20 and more preferably 0 to 15 wt % of at least one further monoethylenically unsaturated monomer.

Useful vinylaromatic monomers include styrene and/or alpha-methylstyrene. Useful further monomers C23 include the monomers mentioned above for component C12. Especially methyl methacrylate and acrylates, such as n-butyl acrylate, are suitable. Very particular suitability for use as monomer C23 is possessed by methyl methacrylate MMA, and an amount of up to 20 wt % of MMA, based on C2, is preferred.

The graft polymers are often prepared by the method of emulsion polymerization. The polymerization temperature is typically in the range from 20 to 100° C., preferably in the range from 30 to 90° C. Customary emulsifiers are generally also used, examples being alkali metal salts of alkyl- or alkylarylsulfonic acids, alkyl sulfates, fatty alcohol sulfonates, salts of higher fatty acids with 10 to 30 carbon atoms, sulfosuccinates, ether sulfonates or resin soaps. Preference is given to using the alkali metal salts, in particular the sodium and potassium salts, of alkylsulfonates or fatty acids having 10 to 18 carbon atoms.

In general, emulsifiers are employed in amounts of 0.5 to 5 wt %, in particular of 0.5 to 3 wt %, based on the monomers employed in the preparation of grafting base C1. The amount of water used for preparing the dispersion is preferably such that the final dispersion has a solids content of 20 to 50 wt %. A water/monomer ratio in the range from 2:1 to 0.7:1 is typically used.

The polymerization reaction can be suitably initiated using any free-radical generators which decompose at the reaction temperature chosen, i.e., not only those which decompose thermally on their own but also those which decompose thermally in the presence of a redox system. The polymerization initiators used are preferably free-radical generators, for example peroxides such as, preferably, peroxosulfates (sodium persulfate or potassium persulfate, for instance) and azo compounds such as azobisisobutyronitrile.

However, it is also possible to employ the redox systems, in particular redox systems based on hydroperoxides such as cumene hydroperoxide.

The polymerization initiators are generally in an amount of 0.1 to 1 wt %, based on grafting base monomers C11 and C12.

The free-radical generators, and also the emulsifiers, are added to the reaction mixture, for example, batchwise by adding the overall quantity at the start of the reaction, or by being subdivided into a plurality of portions which are added at the start and at one or more subsequent junctures, or continuously during a specified time interval. The continuous addition process can also follow a gradient, which may for example be upwardly or downwardly inclined, linear or exponential, or else may be a stepped gradient (step function).

It is further possible to use chain transfer agents such as, for example, ethylhexyl thioglycolate, n- or t-dodecyl mercaptan or other mercaptans, terpinols or dimeric a-methylstyrene or other compounds suitable for controlling the molecular weight. The chain transfer agents are added to the reaction mixture in a batchwise or continuous manner as described above for the free-radical generators and emulsifiers.

To maintain a constant pH, which is preferably in the range from 6 to 9, it is possible to use buffer substances such as Na2HPO4/NaH2PO4, sodium hydrogencarbonate or buffers based on citric acid/citrate. Chain transfer agents and buffer substances are used in the customary amounts, so no further particulars are required in this regard.

In a particularly preferred embodiment, a reducing agent is added during the grafting of grafting base C1 with monomers C21 to C23.

The grafting base in a particular embodiment may also be prepared by polymerization of monomers C1 in the presence of a finely divided latex (so-called “seed latex process” of polymerization). This latex is initially charged and may consist of monomers forming elastomeric polymers, or else of other monomers of the type already mentioned. Suitable seed latices consist for example of polybutadiene or polystyrene.

In another preferred embodiment, grafting base C1 may be formed in the so-called feed stream addition process. In this process, a specified proportion of monomer C1 is initially charged and the polymerization is initiated, whereupon the rest of monomer C1 (“feed stream addition portion”) is added as a feed stream during the polymerization.

The feed stream addition parameters (shape of gradient, amount, duration, etc.) depend on the other polymerization conditions. Again, the particulars offered in respect of the addition process of the free-radical initiator and/or of the emulsifier apply here mutatis mutandis. The initially charged proportion of monomer is preferably from 5 to 50, more preferably from 8 to 40, wt %, based on C1. The feed stream portion of C1 is preferably added over 1-18 hours, in particular 2-16 hours, more particularly 4 to 12 hours.

Also suitable are graft polymers having a plurality of “soft” and “hard” shells, e.g., of the construction C1-C2-C1-C2, or C2-C1-C2, particularly in the case of comparatively large particles.

The precise polymerization conditions, in particular type, amount and the dosage regime of the emulsifier and of the other polymerization assistants are preferably chosen such that the latex obtained for graft polymer C has an average particle size, defined by the d50 value of the particle size distribution, in the range from 80 to 800, preferably in the range from 80 to 600 and more preferably in the range from 85 to 400, as measured using HDC (W. Wohlleben and H. Schuch in Measurement of Particle Size Distribution of Polymer Latexes, 2010, Editors: Luis M. Gugliotta and Jorge R. Vega, pp. 130 to 153).

The reaction conditions are preferably aligned such that the polymer particles of C have a bimodal particle size distribution, i.e., a size distribution with two more or less well-defined maxima. The first maximum is more distinctly defined (as a comparatively narrow peak) than the second maximum and is generally located at from 25 to 200, preferably from 60 to 170 and more preferably from 70 to 150 nm. The second maximum is generally located at 150 to 800, preferably 180 to 700 and more preferably 200 to 600 nm. The second maximum (150 to 800 nm) is located at larger particle sizes than the first maximum (25 to 200 nm).

The bimodal particle size distribution is preferably achieved via a (partial) agglomeration of the polymer particles. A possible procedure for this is for example as follows: monomer C1, which constructs the core, is polymerized up to a conversion of typically not less than 90%, preferably above 95%, based on the monomer used. This conversion is generally reached after 4 to 20 hours. The rubber latex obtained has an average particle size d50 of not more than 200 nm and a narrow particle size distribution (it is an almost monodisperse system).

The rubber latex is agglomerated in the second stage. This is generally accomplished by admixing a dispersion of an acrylic ester polymer. Preference is given to using dispersions of copolymers of C₁-C₄ alkyl esters of acrylic acid, preferably of ethyl acrylate, with 0.1 to 10 wt % of monomers forming polar polymers, e.g., acrylic acid, methacrylic acid, acrylamide or methacrylamide, N-methylolmethacrylamide or N-vinylpyrrolidone. Preference is given to a composition of 80 to 98% ethyl acrylate and 2 to 20% methacrylamide, while particular preference is given to a composition of 90 to 98% ethyl acrylate and 2 to 10% methacrylamide. The agglomeration dispersion may optionally also comprise a plurality of the acrylic ester polymers referred to.

The concentration of acrylic ester polymers in the dispersion used for agglomeration shall generally be between 3 and 40 wt %. The agglomeration utilizes from 0.2 to 20, preferably from 1 to 5 parts by weight of the agglomeration dispersion per 100 parts by weight of the rubber latex, each reckoned on solids. The agglomeration is carried out by admixing the agglomeration dispersion to the rubber. The rate of admixing is normally not critical, it generally takes about 1 to 30 minutes at a temperature between 20 and 90° C., preferably between 30 and 75° C.

Aside from using an acrylic ester polymer dispersion, the rubber latex may also be agglomerated with other agglomeration agents such as, for example, acetic anhydride. Agglomeration is also possible by pressing or freezing (making for a pressure agglomeration and a freeze agglomeration, respectively). The methods mentioned are known to a person skilled in the art.

Under the conditions mentioned, only a portion of the rubber particles is agglomerated, which results in a bimodal distribution. After the agglomeration step, generally more than 50%, preferably between 75% and 95% of the particles (number-based distribution) is in a nonagglomerated state. The partially agglomerated rubber latex obtained is comparatively stable, so it is readily storable and transportable without occurrence of coagulation.

To obtain a bimodal particle size distribution for graft polymer C, it is also possible to form two different graft polymers C′ and C″, which differ in their average particle size, separately from each other in the usual manner and to add graft polymers C′ and C″ together in the desired mixing ratio.

Typically, the reaction conditions for the polymerization of grafting base C1 are chosen so as to produce a grafting base having a specified extent of crosslinking.

Essential parameters therefor may be mentioned by way of example in the reaction temperature and time, the ratio of monomers, chain transfer agents, free-radical initiators and in the case of the feed stream addition process for example, the feed stream addition rate and the amount and the point in time in and at which the chain transfer agent and the initiator are added.

One way to characterize the extent of the crosslinking in crosslinked particles of polymer is to measure the swelling index SI which is a measure of the degree to which a more or less crosslinked polymer is swellable by a solvent. Methyl ethyl ketone and toluene are examples of customary swelling agents. The SI of ungrafted molding compositions C1 according to the present invention is typically in the range SI=10 to 60, preferably in the range from 15 to 55 and more preferably in the range from 20 to 50 in toluene.

Another way to characterize the extent of crosslinking is to measure NMR relaxation times of mobile protons, the so-called T2 times. The greater the extent of crosslinking of a certain network, the lower its T2 times. Customary T2 times for grafting bases C1 of the present invention are average T2 times in the range from 2.0 to 4.5 ms, preferably in the range from 2.5 to 4.0 ms and more preferably in the range from 2.5 to 3.8 ms, as measured on filmed samples at 80° C.

A further measure to characterize the grafting base and its extent of crosslinking is the gel content, i.e., that proportion of the product which is in a crosslinked state and hence insoluble in a specified solvent. The gel content is sensibly determined in the same solvent as the swelling index. Customary gel contents of grafting bases C1 according to the present invention are in the range from 50 to 90%, preferably in the range from 55 to 85% and more preferably in the range from 60 to 80%.

The swelling index is determined, for example, by the following method: about 0.2 g of the solid material of a grafting base dispersion which has been filmed by evaporating the water is insipidly swollen in a sufficiently large amount (50 g, for example) of toluene. After 24 h, for example, the toluene is removed by suction and the sample is weighed. After the sample has dried under reduced pressure, it is reweighed. The swelling index is the ratio of the weight after the swelling process to the drying weight after the renewed drying. Correspondingly, the gel content computes as the ratio of the dried weight after the swelling step to the initial weight before the swelling step (100%).

The T2 time is determined by measuring the NMR relaxation of a dewatered and filmed sample of the grafting base dispersion. For this purpose, for example, the sample is air dried overnight and then vacuum dried, for example at 60° C. for 3 h, and then measured with a suitable measuring instrument (e.g., a Minispec instrument from Bruker), at 80° C. Comparability only exists for samples which have been measured by the same procedure, since the relaxation process is distinctly temperature-dependent.

Graft C2 can be formed under the same conditions as used for forming grafting base c1, in which case graft C2 may be formed in one or more steps. In a two-stage grafting, for example, initially styrene or α-methylstyrene can be polymerized alone followed by styrene and acrylonitrile in two successive steps. This two-stage grafting (initially styrene, then styrene/acrylonitrile) is a preferred embodiment. Further details regarding production of graft polymers C are described in DE 12 60 135 and 31 49 358.

It is advantageous for the graft polymerization onto grafting base C1 to be in turn carried out in aqueous emulsion. The graft polymerization can be carried out in the same system as the polymerization of the grafting base, in which case emulsifier and initiator can further be added. These do not have to be identical to the emulsifiers and/or initiators used for producing grafting base C1. For instance, it can be advantageous to use a persulfate initiator for producing grafting base C1, but a redox initiator system for polymerizing grafted sheath C2. The choice of emulsifier, initiator and polymerization assistants is subject to the remarks made in connection with the preparation of grafting base C1. The monomer mixture to be grafted onto the grafting base may be added to the reaction mixture all at once, batchwise in two or more stages or preferably continuously during the polymerization.

Insofar as ungrafted polymers are formed from monomer C2 in the course of the grafting of grafting base C1, the amounts, which are generally below 10 wt % of C2, are assigned to the mass of component C.

Graft copolymers C of the present invention can be further used as obtained in the reaction mixture, for example as latex emulsion or dispersion. Alternatively—and this is preferable for most applications—they can also be worked up in a further step. Workup measures are known to a person skilled in the art.

They include, for example, graft copolymers C being isolated from the reaction mixture, for example by spray drying, shearing or by precipitation with strong acids or means of nucleating agents such as inorganic compounds e.g. magnesium sulfate. However, as-obtained graft copolymers C can also be worked up from the reaction mixture by complete or partial dewatering. Another possibility is to work up by means of a combination of the measures referred to.

The SI of the graft copolymers is typically in the range SI=7 to 20, preferably in the range from 8 to 15 and more preferably in the range from 8 to 13.

The mixing of components B and C to form the molding composition can be effected in any desired manner by any known methods. When these components have been formed by emulsion polymerization, for example, it is possible for the polymer dispersions obtained to be mixed with one another, then to conjointly precipitate the polymers and to work up the polymer mixture. Preferably, however, these components are blended by being conjointly extruded, kneaded or rolled, for which the components have been isolated beforehand as necessary from the as-polymerized solution or aqueous dispersion. The graft copolymerization products B obtained in aqueous dispersion can also be dewatered only partially and mixed in the form of moist crumb with the hard matrix B, in which case graft copolymers C then dry completely during the mixing.

### COMPONENT D

Component D of the molding compositions according to the present invention comprises a compound of formula (I):

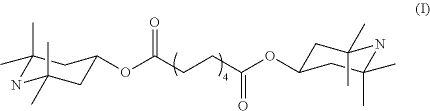

This sterically hindered amine (CAS number 52829-07-9) and its method of making are described in the literature (U.S. Pat. No. 4,396,769 and the literature references cited therein). It is marketed by BASF SE under the designation Tinuvin® 770. The amount of component D is often from 0.3 to 1.1 wt % of the molding composition.

### COMPONENT E

Component E of the molding compositions according to the present invention comprises a compound of formula (II):

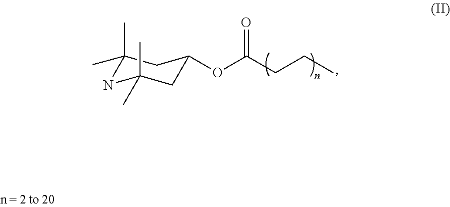

in particular of the following formula:

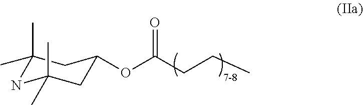

These sterically hindered amines, such as for example CAS number 167078-06-0 and their method of making are known to a person skilled in the art and described in the literature (Carlsson, Journal of Polymer Science, Polymer Chemistry Edition (1982), 20(2), 575-82). The product of CAS number 167078-06-0 is marketed for example by Cytec Industries under the designation Cyasorb® 3853. The sterically hindered amine of formula (II) can also be present in polypropylene in concentrations of 1 to 60%, as marketed for example by Cytec Industries under the designation Cyasorb® 3853 PP5, and be incorporated together with polypropylene. The amount of component E is often 0.2 to 0.7 wt % of the molding composition.

### COMPONENT F

Component F of the molding compositions according to the present invention may be a compound of formula (III):

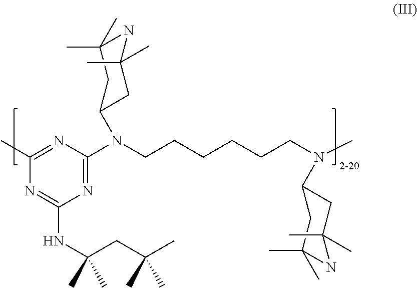

This sterically hindered amine (CAS number 71878-19-8) and its method of making are described in the literature (EP-A 093 693 and the literature references cited therein). It is marketed by BASF SE under the designation Chimassorb® 944.

Component F of the molding compositions according to the present invention may further be a compound of formula (IV):

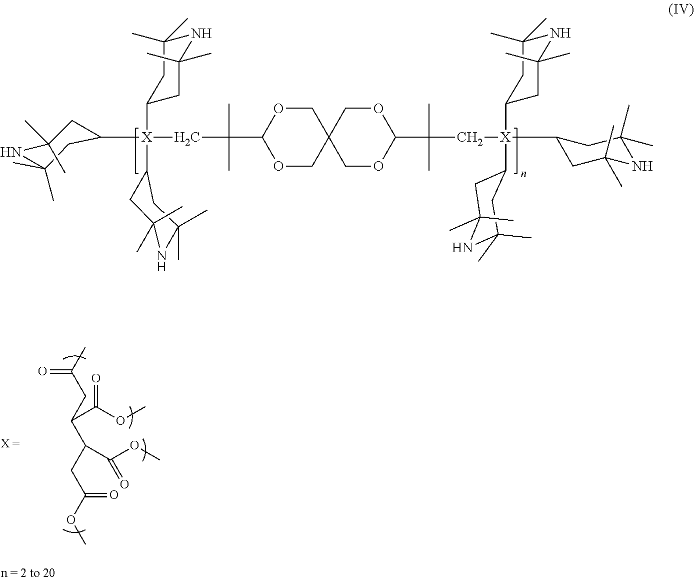

This sterically hindered amine (CAS number 101357-37-3) and its method of making are described in the literature (U.S. Pat. No. 5,208,132 and the literature references cited therein). It is marketed by ADEKA under the designation Adeka Stab® LA-68.

Component F of the molding compositions according to the present invention may further be a compound of formula (V):

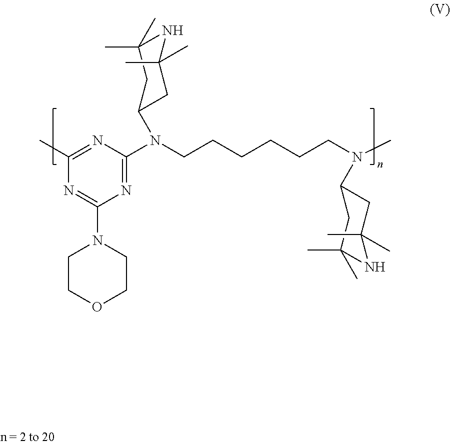

This sterically hindered amine (CAS number 82451-48-7) and its method of making are described in the literature (U.S. Pat. No. 4,331,586 and the literature references cited therein). It is marketed by Cytec Industries under the designation Cyasorb® UV-3346.

Component F of the molding compositions according to the present invention may further be a compound of formula (VI):

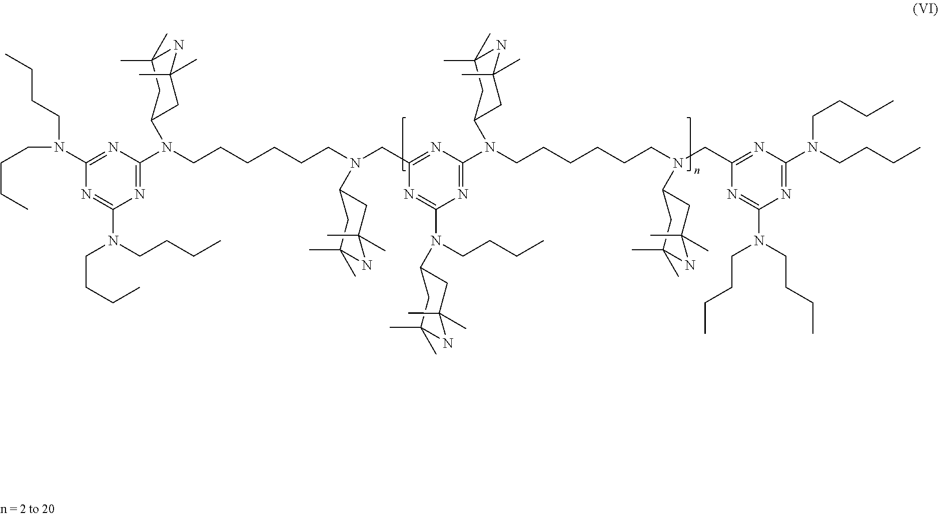

This sterically hindered amine (CAS number 192268-64-7) and its method of making are described in the literature (EP-A 0 782 994 and the literature references cited therein). It is marketed by BASF SE under the designation Chimassorb® 2020.

The amount of component F is often (if present) in the range from 0.2 to 0.8 wt % of the molding composition.

### COMPONENT G

Component G of the thermoplastic molding compositions of the present invention also comprises styrene copolymers which, based on overall component G, include from 0.5 to 5 wt %, preferably 1.0 to 2.5, in particular 1.7 to 2.3 wt % of maleic anhydride-derived units. This proportion of units is with particular preference in the range from 2.0 to 2.2 wt % and is specifically about 2.1 wt %.

It is particularly preferable for component G to be a styrene-acrylonitrile-maleic anhydride terpolymer or a styrene-N-phenylmaleimide-maleic anhydride terpolymer.

The proportion of acrylonitrile in the terpolymer is preferably in the range from 10 to 30 wt %, more preferably in the range from 15 to 30 wt % and in particular in the range from 20 to 25 wt %, based on the overall terpolymer. The rest remaining is accounted for by styrene and the third monomer.

The copolymers generally have molecular weights M_{w} in the range from 30 000 to 500 000 g/mol, preferably from 50 000 to 250 000 g/mol, particularly from 70 000 to 200 000 g/mol, as determined by GPC using tetrahydrofuran (THF) as eluent and with polystyrene calibration.

The copolymers of component G are obtainable by free-radical polymerization of the corresponding monomers. Their preparation is more particularly explicated for example in WO 2005/040281, page 10, line 31 to page 11, line 8.

It is further also possible to use styrene-N-phenylmaleimide-maleic anhydride terpolymers as component G. Reference can be made to the descriptions in EP-A 0 784 080 and also DE-A 100 24 935, and also to DE-A 44 07 485, description of component B there on pages 6 and 7.

Component G is often comprised in the molding composition in an amount of 3 to 7 wt %.

### COMPONENT H

The molding compositions of the present invention may include an additional component H which comprises at least one rubber (different rubber than component C). Optionally, mixtures of two or more rubbers can also be employed. Preferably, the thermoplastic molding compositions comprise an additional rubber if component H is present in the molding compositions of the present invention.

Suitable for use as component H (rubber H) are grafted or ungrafted, nonparticulate rubbers without core-shell structure which have functional groups capable of reacting with the end groups of component A (polyamide).

Suitable functional groups are for example:

carboxylic acid, carboxylic anhydride, carboxylic ester, carboxamide, carboximide, amino, hydroxyl, epoxy, urethane and oxazoline groups.

Suitable monomers for introducing the functional groups include, for example, maleic anhydride, itaconic acid, acrylic acid, glycidyl acrylate and glycidyl methacrylate. These monomers may be reacted, for example grafted, with the starting rubber by methods known to a person skilled in the art, for example in the melt or in solution, optionally in the presence of a free-radical initiator such as cumene hydroperoxide.

Suitable rubbers H include, for example, copolymers of α olefins having functional groups capable of reacting with the end groups of component A. The α olefins are typically monomers having 2 to 8 carbon atoms, preferably ethylene and propylene, in particular ethylene. Useful comonomers include, in particular, alkyl acrylates or alkyl methacrylates which derive from alcohols having 1 to 8 carbon atoms, preferably from ethanol, butanol or ethylhexanol, and also reactive comonomers such as acrylic acid, methacrylic acid, maleic acid, maleic anhydride or glycidyl (meth)acrylate and also vinyl esters, in particular vinyl acetate. Mixtures of various comonomers can likewise be used. Copolymers of ethylene with ethyl or butyl acrylate and acrylic acid and/or maleic anhydride are particularly suitable.

A further preferred embodiment of these rubbers H are ethylene-propylene copolymers (“EP rubbers”) which have functional groups capable of reacting with the end groups of component A.

Suitable for use as particularly preferred rubbers H are those based on ethylene and octene, which have functional groups capable of reacting with the end groups of component A. Suitable in particular are maleic anhydride-grafted ethylene-octene copolymers, for example the commercial product Fusabond® MN 493D from DuPont.

These copolymers are obtainable in a high-pressure process at a pressure of 400 to 4500 bar or by grafting the comonomers onto a poly-α-olefin. The proportion of the copolymer which is attributable to the α-olefin is typically in the range from 99.95 to 55 wt %.

Suitable rubbers H are for example ones constructed from ethylene, propylene and a diene monomer (“EPDM rubber”), which have functional groups capable of reacting with the end groups of component B). The EPDM rubbers used preferably have a glass transition temperature in the range from −60 to −40° C. The EPDM rubbers have only a minimal number of double bonds per 1000 carbon atoms, in particular from 3 to 10 double bonds per 1000 carbon atoms. Examples of such EPDM rubbers are terpolymers of at least 30 wt % of ethylene, at least 30 wt % of propylene and 0.5 to 15 wt % of a nonconjugated diolefinic component. A suitable functionalized EPDM rubber is for example the Royaltuf® 485 product from Chemtura.

The diene monomer component used for EPDM rubbers generally comprises diolefins having at least 5 carbon atoms, such as 5 ethylidenenorbornene, dicyclopentadiene, 2,2,1-dicyclopentadiene and 1,4-hexadiene. It is further possible to use polyalkyleneamers such as polypentamers, polyocteneamers, polydodecaneamers or mixtures thereof. It is further also possible to use partially hydrogenated polybutadiene rubbers where at least 70% of the remaining double bonds are hydrogenated. EPDM rubbers generally have a Mooney viscosity ML₁₋₄(100° C.) in the range from 25 to 120. They are commercially available.

Suitable rubbers H further include those formed from vinylaromatic monomers and dienes, for example styrene and butadiene or isoprene, where the dienes may be wholly or partly hydrogenated, that have functional groups capable of reacting with the end groups of component A. Copolymers of this type may, for example, have a random construction or a block-type structure made up of vinylaromatic blocks and diene blocks, or a tapered structure (with a gradient along the polymer chain from diene lean to diene rich). The copolymers may have a linear, branched or star-shaped construction. The block copolymers may have two or more blocks, and the blocks may also be random or tapered.

Suitable styrene-butadiene copolymers are, for example, diblock copolymers styrene-butadiene (“SB”), triblock copolymers styrene-butadiene-styrene (“SBS”) and, in particular, hydrogenated triblock copolymers styrene-ethenbutene-styrene (“SEBS”). Such copolymers of styrene and dienes are for example available from BASF SE as Styrolux® or Styroflex®. Anhydride group-functionalized styrene-ethenebutene block copolymers are commercially available as Kraton® FG-1901 FX for example.

The recited block copolymers are typically formed via sequential anionic polymerization. In a sequential anionic polymerization, for example, first styrene is polymerized with an organolithium initiator to form a styrene block, then butadiene is added and polymerized onto the styrene block as a butadiene block, optionally further styrene is then added and a styrene block polymerized onto the existing species. Any hydrogenation of the diene blocks is generally effected catalytically under positive hydrogen pressure.

### COMPONENT I

In addition to components A, B, C, D, E, F, G and H, the molding compositions according to the present invention may comprise one or more additive/added-substance materials other than components D, E, F, G and H and as typical and customary for mixtures of plastics.

Examples of such additive/added-substance materials are: dyes, pigments, colorants, antistats, antioxidants, stabilizers to improve thermal stability, to enhance hydrolysis resistance and chemical resistance, agents against thermal decomposition and in particular the lubricants/glidants that are useful for production of moldings and/or molded articles. These further added-substance materials may be admixed at every stage of the manufacturing operation, but preferably at an early stage in order to profit early on from the stabilizing effects (or other specific effects) of the added-substance material. Heat stabilizers and oxidation retarders are typically metal halides (chlorides, bromides, iodides) and are derived from metals of group I of the periodic table (such as Li, Na, K, Cu).

Stabilizers useful as component I include the customary hindered phenols, but also “vitamin E” and/or similarly constructed compounds. Benzophenones, resorcinols, salicylates, benzotriazoles and other compounds are also suitable. These are typically used in amounts of 0 to 2 wt %, preferably 0.01 to 2 wt % (based on the overall weight of molding compositions according to the present invention).

Suitable gliding and demolding agents include stearic acids, stearyl alcohol, stearic esters and/or generally higher fatty acids, their derivatives and corresponding fatty acid mixtures having 12 to 30 carbon atoms. Use levels for these additions—if present—range from 0.05 to 1 wt % (based on the overall weight of molding compositions according to the present invention).

Useful added-substance materials further include silicone oils, oligomeric isobutylene or similar materials, typical usage levels—if present—amounting mainly from 0.05 to 5 wt % (based on the overall weight of molding compositions according to the present invention). Pigments, dyes, color brighteners, such as ultramarine blue, phthalocyanines, titanium dioxide, cadmium sulfides, derivatives of perylenetetracarboxylic acid can likewise be used.

Processing aids, lubricants and antistats are typically used in amounts of 0 to 2 wt %, preferably 0.01 to 2 wt % (based on the overall weight of molding compositions according to the present invention).

The molding compositions may comprise for example 0 to 17 wt %, often 0 to 5 wt % of component I, which may often also be carbon black.

### COMPONENT J

Component J of the molding compositions according to the present invention comprises fibrous or particulate fillers (or mixtures thereof) other than components A to I. It is preferable for commercially available products to be concerned here, for example carbon fibers and glass fibers.

Usable glass fibers may be of E-, A- or C glass, and are preferably finished with a sizing agent and a coupling agent. Their diameter is generally between 6 and 20 μm. Not only continuous-filament fibers but also chopped glass fibers (staple) or rovings having a length of 1 to 10 mm, preferably 3 to 6 mm, can be used.

It is further possible for filling and reinforcing materials, such as glass beads, mineral fibers, whiskers, alumina fibers, mica, quartz flour and wollastonite to be added as component J.

In addition to components A, B, C, D, E, F, G, and optionally H, I and J, the molding compositions according to the present invention may comprise further polymers.

The process of producing the molding compositions of the present invention from the components can be carried out in any desired manner by any known method. Preferably, the components are blended by melt mixing, for example conjoint extrusion, kneading or rolling of the components, for example at temperatures in the range from 160 to 400° C., preferably from 180 to 280° C.

In a preferred embodiment, the components have first been partially or completely isolated from the reaction mixtures obtained in the particular steps of the production process. For example, graft copolymers C can be mixed in the form of moist crumb with pellets of vinylaromatic copolymer B, in which case complete drying to the graft copolymers described then takes place during mixing.

The components may be supplied, each in pure form, to suitable mixing devices, in particular extruders, preferably twin-screw extruders. However, individual components, for example B and C, can also be first premixed and then mixed with further components B or C or other components, for example D and E. Component B may be employed as a component which is produced separately beforehand. It is also possible for the rubber and the vinylaromatic copolymer to be dosed independently from one another.

In one embodiment, a concentrate, for example of components D and E in component B, is prepared first (to obtain a masterbatch or an additive batch) and then mixed with the desired amounts of the remaining components. The molding compositions may be processed by methods known to those skilled in the art to form pellets, for example, or else be processed directly to form molded articles, for example.

The molding compositions of the present invention may be processed to form self-supporting films or sheets, molded articles or fibers. These self-supporting films or sheets, molded articles or fibers are suitable for use in particular in the outdoor sector, i.e., under weathering conditions. These self-supporting films or sheets, molded articles or fibers are obtainable from the molding compositions of the present invention by the known methods of thermoplastic processing. More particularly, their production can take the form of thermoforming, extrusion, injection molding, calendering, blow molding, compression molding, press sintering, deepdrawing or sintering, preferably by injection molding.

The molding compositions of the present invention versus the known stabilized molding compositions have a further improved resistance to weathering, i.e., a further improved resistance to heat, light and/or oxygen. This holds particularly for molding compositions comprising the specific components A-i, A-ii, B-i, C-i, D-i, E-i, F-i, F-ii, G-i and/or I-i recited in the experimental section.

The following examples and claims further elucidate the invention.

### A) Methods of Measurement:

Notched impact strength of products was determined at room temperature on ISO bars to ISO 179 1eA.

Heat resistance of samples was determined as the Vicat softening temperature. The Vicat softening temperature was determined to German standard specification DIN 53 460, using a force of 49.05 N and a temperature increase of 50 K per hour, on standardized small bars.

Surface gloss of all samples was measured to German standard specification DIN 67530 at a 60° viewing angle.

To obtain a measure of weathering resistance, test specimens (60×60×2 mm, produced to ISO 294 in a family mold at a melt temperature of 260° C. and a mold temperature of 60° C.) were subjected to weatherization by Xenon test to ISO 4892/2, method A, outside. The samples were not subjected to any additional treatment after weatherization. Weatherization time of 300 h and 600 h (h=hour) referred to in Table 1 was followed by evaluation of the surface in terms of the gray scale (5: no change, 1: massive change) to ISO 105-A02 (1993).

To obtain a further measure of weathering resistance, the color space color difference ΔE of German standard specification DIN 52 336 was calculated from ΔL, Δa and Δb according to German standard specification DIN 6174.

Further, penetration or multi-axial toughness was determined as a further measure of weathering resistance on small plaques (60×60×2 mm produced to the ISO 294 standard in a family mold at a melt temperature of 260° C. and a mold temperature of 60° C.) to ISO 6603-2 at room temperature.

### B) Materials Used

Components or products with a prefixed “V-” are not in accordance with the present invention, they are offered for comparison.

The following were used as component A (or V-A for comparison):
A-i: the polyamide used was a nylon-6, obtained from ε-caprolactam, having a viscosity number of 150 ml/g (measured in a 0.5 wt % concentration in 96 wt % sulfuric acid), commercially available, for example, from BASF SE® under the designation Ultramid® B 3.
A-ii: the polyamide used was a nylon-6, obtained from ε-caprolactam, having a viscosity number of 130 ml/g (measured in a 0.5 wt % concentration in 96 wt % sulfuric acid) and a proportion of triacetonediamine of 0.16 wt %.
V-A-ii a Moplen® HP500N polypropylene commercially available from LyondellBasell Industries AF S.C.A.
V-A-iii: Polystyrol® 158K polystyrene commercially available from BASF SE.

The following was used as component B:
B-i: a styrene-acrylonitrile copolymer with 75 wt % of styrene and 25 wt % of acrylonitrile and a viscosity number of 80 ml/g (determined in 0.5 wt % DMF solution at 25° C.).

The following were used as component C (or V-C for comparison):
C-i: a grafted butadiene rubber synthesized as described in Example A6 of DE 197 28 629 A1.
   C-i₁ 41 826.4 g of butadiene and 1293.6 g of styrene are polymerized in the presence of 432 g of tert-dodecyl mercaptan (TDM), 311 g of the potassium salt of C₁₂-C₂₀ fatty acids, 82 g of potassium persulfate, 147 g of sodium hydrogencarbonate and 58 400 g of water at 65° C. to form a polybutadiene latex. The specific procedure adopted was as described in EP-A 62901, Example 1, page 9, line 20 to page 10, line 6, except that the TDM was added as one portion at the start of the reaction. The conversion was 98%. The average particle size d₅₀ of the latex was 134 nm, the swelling index was 20.3. The T₂ time determined by NMR was from 3.8 to 2.9 ms.
      To agglomerate the latex, 35 000 g of the latex obtained were agglomerated at 65° C. by admixture of 2700 g of a dispersion (solids content 10 wt %) of 96 wt % of ethyl acrylate and 4 wt % of methacrylamide.
   C-i₂ The agglomerated latex was admixed with 9000 g of water, 130 g of the potassium salt of C₁₂-C₂₀ fatty acids and 17 g of potassium peroxodisulfate. Then, 18 667 g of styrene and 4666 g of acrylonitrile were added at 75° C. under agitation in the course of 4 hours. The conversion, based on the grafting monomers, was almost quantitative. The graft polymer dispersion obtained had a bimodal particle size distribution. The particle size distribution had a first maximum at 166 nm and a second maximum at 442 nm.
      The dispersion obtained was admixed with an aqueous dispersion of an antioxidant and then coagulated by admixture with a magnesium sulfate solution. The coagulated rubber was removed from the dispersion liquid by centrifugation and washed with water. The rubber obtained had about 30 wt % of adherent and/or enclosed residual water.
      The swelling index of C-i in toluene was found to be 8.8.
V-C-ii: The procedure for component C-i was repeated using 44 g of tert-dodecyl mercaptan (TDM) instead of 432 g of tert-dodecyl mercaptan (TDM). The T₂ time determined by NMR was from 3.5 to 2.5 ms. After grafting as described in C-i₂ the swelling index in toluene was 6.3. The average particle size was determined as 316 nm.

The following were used as component D (or V-D for comparison):
D-i: a compound of formula (I), commercially available from BASF SE under the designation Tinuvin® 770.
V-D-ii: a compound of formula (XII), commercially available from BASF SE under the designation Tinuvin® 765.

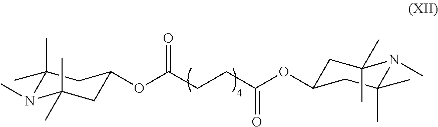

The following was used as component E:
E-i: a compound of formula (IIa), commercially available from Cytec Industries under the designation Cyasorb® 3853.

The following were used as component F (or V-F for comparison):
F-i: a compound of formula (III), commercially available from BASF SE under the designation Chimassorb® 944.
F-ii: a compound of formula (V), commercially available from Cytec Industries under the designation Cyasorb® UV-3346.
V-F-iii: a high molecular weight sterically hindered amine of formula (XIII), CAS number 106990-43-6, commercially available from SABO S.p.A. under the designation Sabostab® 119.

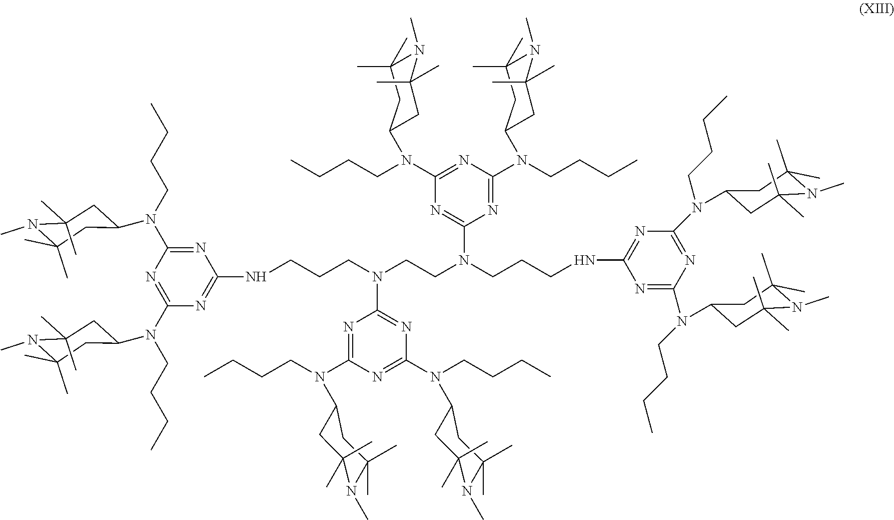

The following was used as component G:
G-i: a styrene-acrylonitrile-maleic anhydride terpolymer having a composition of: 74.4 wt % of styrene; 23.5 wt % of acrylonitrile and 2.1 wt % of maleic anhydride (according to infrared measurement) and a viscosity number of 66 ml/g (determined in 0.5 wt % DMF solution at 25° C.).

The following was used as component I:
I-i: Black Pearls 880 carbon black commercially available from Cabot Corporation.

### Producing the Molding Compositions and Molded Articles:

The components A, B, C, D, E, F, G and I (see table 1 for respective parts by weight) were homogenized at 280° C. in a ZSK30 twin-screw extruder (from Werner & Pfleiderer) and extruded therefrom into a water bath. The extrudates were pelletized and dried. The pellets were used to injection mold at 260° C. melt temperature and 60° C. mold surface temperature test specimens to determine the properties referred to in table 1.

TABLE 1
Ingredient lineup and properties of molding compositions
(prefixed V: for comparison)

| | Example | | | | | | | | | | |
|---|---|---|---|---|---|---|---|---|---|---|---|
| | V-1 | 2. | 3. | 4. | 5. | V-6 | V-7 | V-8 | V-9 | V-10 | V-11 |
| Lineup | | | | | | | | | | | |
| A-i | 40 | 40 | 40 | 40 | | | | | 40 | 40 | 40 |
| A-ii | | | | | 40 | | | | | | |
| V-A-iii | | | | | | 98.8 | | | | | |
| V-A-iv | | | | | | | 98.8 | 98 | | | |
| B-i | 19 | 18 | 18 | 18 | 18 | | | | 18 | 18 | 18 |
| C-i | 35 | 35 | 35 | 35 | 35 | | | | | 35 | 35 |
| V-C-ii | | | | | | | | | 35 | | |
| D-i | | 0.5 | 0.5 | 0.5 | 0.5 | 0.1 | 0.1 | 0.5 | 0.5 | | 0.5 |
| V-D-ii | | | | | | | | | | 0.5 | |
| E-i | | 0.5 | 0.25 | | 0.5 | 0.1 | 0.1 | 0.5 | 0.5 | 0.5 | |
| F-i | | | 0.25 | | | | | | | | |
| F-ii | | | | 0.5 | | | | | | | |
| V-F-iii | | | | | | | | | | | 0.5 |
| G-i | 5 | 5 | 5 | 5 | 5 | | | | 5 | 5 | 5 |
| I-i | 1 | 1 | 1 | 1 | 1 | 1 | 1 | 1 | 1 | 1 | 1 |
| ak (kJ/m2) | 49 | 53 | 51 | 54 | 48 | 2 | 2 | 2 | 29 | 52 | 50 |
| Vicat B [° C.] | 102 | 100 | 99 | 101 | 99 | 86 | 101 | 99 | 100 | 101 | 100 |
| gloss | 91 | 91 | 93 | 92 | 91 | 85 | 102 | 103 | 83 | 92 | 91 |
| grayness | | | | | | | | | | | |
| after | | | | | | | | | | | |
| 0 h BWZ | 5 | 5 | 5 | 5 | 5 | 5 | 5 | 5 | 5 | 5 | 5 |
| 300 h BWZ | 1 | 4 | 4 | 4 | 4 | 5 | 5 | 5 | 3 | 2 | 2 |
| 600 h BWZ | 1 | 4 | 4 | 4 | 4 | 5 | 1 | 3 | 1 | 1 | 1 |
| ΔE after | | | | | | | | | | | |
| 0 h BWZ | 0 | 0 | 0 | 0 | 0 | 0 | 0 | 0 | 0 | 0 | 0 |
| 300 h BWZ | 17 | 0 | 0 | 0 | 0 | 1 | 2 | 1 | 8 | 10 | 9 |
| 600 h BWZ | 18 | 1 | 0 | 0 | 1 | 1 | 2 | 2 | 13 | 15 | 12 |
| penetration | | | | | | | | | | | |
| after | | | | | | | | | | | |
| 0 h BWZ | 45 | 42 | 44 | 40 | 33 | 4 | 1 | 1 | 36 | 46 | 45 |
| 300 h BWZ | 13 | 33 | 37 | 34 | 26 | 2 | 0 | 1 | 21 | 22 | 28 |
| 600 h BWZ | 5 | 27 | 29 | 27 | 17 | 0 | 0 | 0 | 9 | 12 | 14 |

The examples demonstrate that the inventive molding compositions comprising at least components A, B, C, D and G have an improved resistance to weathering, i.e., an improved resistance to heat, light, and/or oxygen, over the known stabilized molding compositions. The ingredient line ups are reported in weight fractions, the abbreviation BWZ stands for weatherization time. It proved to be particularly favorable to employ component D-i in combination with component E-i.

1. A thermoplastic molding composition comprising the following components:
a) 3 to 91.8 wt % of at least one polyamide, as component A
b) 3 to 91.8 wt % of one or more styrene copolymers without any maleic anhydride-derived units, as component B
c) 5 to 91.8 wt % of one or more impact-modifying grafted rubbers with olefinic double bonding in the rubber phase, as component C
d) 0.2 to 1.5 wt % of a compound of formula (I), as component D: 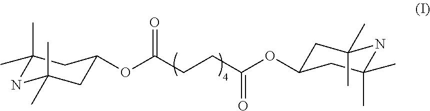
e) 0 to 0.9 wt % of a mixture of formula (II), as component E: 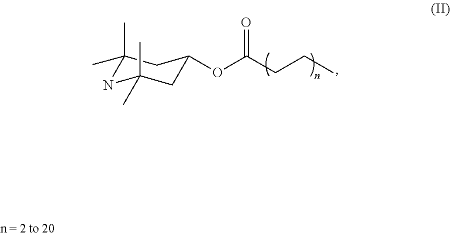
f) 0 to 0.9 wt % of a compound of formula (III), as component F: 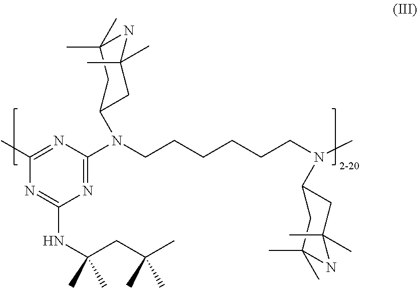
or 0 to 0.9 wt % of a compound of formula (IV): 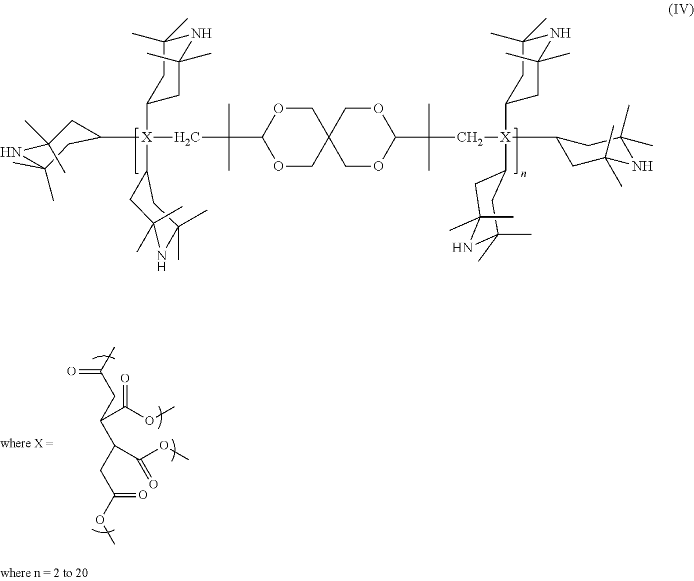
or 0 to 0.9 wt % of a compound of formula (V): 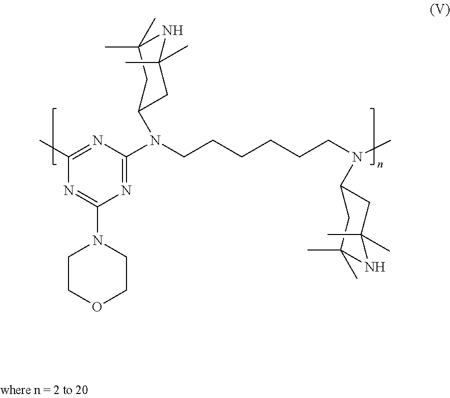
or 0 to 0.9 wt % of a compound of formula (VI): 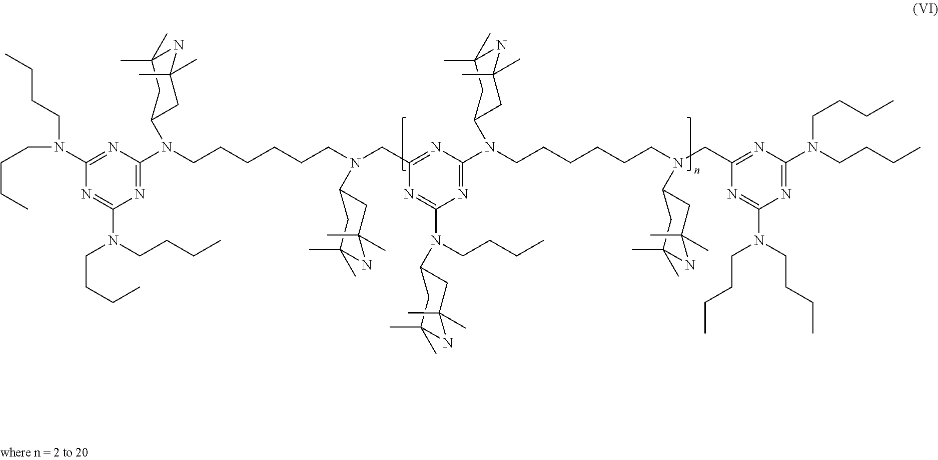
g) 1 to 25 wt % of one or more styrene copolymers which, based on overall component G, include from 0.5 to 5 wt % of maleic anhydride-derived units,
h) 0 to 40 wt % of one or more further rubbers,
i) 0 to 40 wt % of one or more added-substance materials other than components D, E, F, G, and H, as component I, and
j) 0 to 40 wt % of one or more fibrous or particulate fillers, as component J,
with the proviso that when component E amounts to precisely 0 wt %, component F amounts to 0.01 to 0.9 wt % of one or more of compounds III, IV, V or VI, wherein the weight % are each based on the overall weight of components A to J and add up to 100 wt %.

2. The thermoplastic molding composition according to claim 1, characterized in that the swelling index of component C is in the range from 7 to 20.

3. The thermoplastic molding composition according to claim 1, characterized in that component B comprises a copolymer of acrylonitrile, styrene and/or α-methylstyrene, phenylmaleimide, methyl methacrylate or mixtures thereof.

4. The thermoplastic molding composition according to claim 1, characterized in that component C comprises a mixture of an acrylonitrile-butadiene-styrene (ABS) graft polymer comprising 50 to 80 wt %, based on C, of an elastomer-crosslinked butadiene polymer B1 and 50 to 20 wt %, based on C, of a grafted sheath C2 formed from a vinylaromatic monomer and one or more polar, copolymerizable, ethylenically unsaturated monomers, optionally a further copolymerizable, ethylenically unsaturated monomer in a weight ratio of from 85:15 to 65:35.

5. The thermoplastic molding composition according to claim 1, characterized in that the average particle diameter of component C is between 50 to 800 nm.

6. The thermoplastic molding composition according to claim 1, characterized in that components D:E are used in a weight ratio of from 4:1 to 0.25:1.

7. The thermoplastic molding according to claim 1, characterized in that the vinylaromatic component in C2 comprises styrene or α-methylstyrene.

8. The thermoplastic molding composition according to claim 1, characterized in that the ethylenically unsaturated component in C2 comprises acrylonitrile and/or alkyl methacrylates and/or alkyl acrylates having C₁-C₈ alkyls.

9. The thermoplastic molding composition according to claim 1, characterized in that component C comprises a rubber which has a bimodal particle size distribution.

10. The thermoplastic molding composition according to claim 1, characterized in that component G includes from 1.0 to 2.5 wt % of maleic anhydride-derived units.

11. The thermoplastic molding composition according to claim 10, characterized in that component G includes from 1.7 to 2.3 wt % of maleic anhydride-derived units.

12. The thermoplastic molding composition according to claim 1, characterized in that component A includes from 0.05 to 0.5 wt % of triacetonediamine (TAD) end groups.

13. A process for producing thermoplastic molding compositions according to claim 1, characterized in that components A, B, C, D and G, and also optionally E, F, H, I and J are mutually mixed with one another in any desired order at temperatures of 100 to 300° C. and a pressure of 1 to 50 bar, then kneaded and extruded.

14. The process of claim 13 wherein the thermoplastic molding composition produced is a molded article, a self-supporting film and a self-supporting sheet or a fiber.

15. A molded article, a fiber or a self-supporting film or sheet comprising of a thermoplastic molding composition according to claim 1.

16. The thermoplastic molding composition according to claim 1, with the proviso that when component E amounts to precisely 0 wt %, component F amounts to 0.1 to 0.9 wt % of one or more of compounds III, IV, V or VI, wherein the weight % are each based on the overall weight of components A to J and add up to 100 wt %.

17. The thermoplastic molding composition according to claim 1, with the proviso that when component E amounts to precisely 0 wt %, component F amounts to 0.2 to 0.9 wt % of one or more of compounds III, IV, V or VI, wherein the weight % are each based on the overall weight of components A to J and add up to 100 wt %.
